(19) United States
(12) Patent Application Publication
(10) Pub. No.: US 2020/0320069 A1
(43) Pub. Date: Oct. 8, 2020

(54) HYBRID COMPILATION FRAMEWORK FOR ARBITRARY AD-HOC IMPERATIVE FUNCTIONS IN DATABASE QUERIES

(71) Applicant: SAP SE, Walldorf (DE)

(72) Inventors: Taeyoung Jeong, Seoul (KR); Chanho Jeong, Seoul (KR); Ki Hong Kim, Seoul (KR)

(21) Appl. No.: 16/372,652

(22) Filed: Apr. 2, 2019

(51) Int. Cl. G06F 16/242; G06F 16/9038; G06F 16/2455; G06F 16/2453; G06F 16/2452

(52) U.S. Cl. CPC G06F 16/2448; G06F 16/9038; G06F 16/24522; G06F 16/2455; G06F 16/2453; G06F 16/2423

(57) ABSTRACT

Implementations of the present disclosure include providing a parse tree including a declarative portion and an imperative portion, dividing the parse tree to provide a first parse sub-tree and a second parse sub-tree, compiling the first parse sub-tree using a declarative compiler to provide a query execution plan (QEP) including an imperative script operator to prompt execution of the imperative portion, compiling the second parse sub-tree using an imperative compiler to provide one or more script execution plans, executing, by an execution engine, the QEP until encountering an imperative script operator, and, in response to encountering the imperative script operator, initiating execution of the one or more script execution plans to provide an imperative result, and providing a query result at least partially including the imperative result.

### BACKGROUND

Database systems store data that can be queried. For example, a query can be submitted to a database system, which processes the query and provides a result. Queries are submitted in a query language. An example query language includes, without limitation, the structured query language (SQL), which can be described as a standard database language that is used to create, maintain and retrieve data stored in a relational database (e.g., a database, in which data is stored in relational tables).

Query languages, such as SQL, however, can have limitations. For example, SQL is a declarative language that enables processing of declarative queries. A declarative language is a programming language that defines what query result is wanted, but does not specify how to achieve the query result. For example, a SQL query follows a convention of selecting what is wanted, where it is found, and any filters that are to be applied (e.g., SELECT . . . FROM . . . WHERE statement). In contrast, an imperative language is a programming language that defines how to obtain a query result, but does not define what query result is wanted.

While a query language, such as SQL, is good for expressing a single query in a declarative way, traditional uses cases often demand imperative logic as well. For example, the imperative logic is used to express conditions, iterations, and exceptions together with multiple queries. In some database systems, database user-defined functions (UDFs) can be used to express imperative logic in queries. However, UDF is a persistent database object that is stored and maintained within the database system. Managing persistent database objects, such as UDFs, is a burden on resources (e.g., memory, processors) of the database system, as well as on database programmers and administrators.

### SUMMARY

Implementations of the present disclosure include computer-implemented methods for querying a database system. More particularly, implementations of the present disclosure are directed to a hybrid compilation framework for processing queries having arbitrary ad-hoc imperative functions.

In some implementations, actions include receiving a query including declarative logic and imperative logic, providing a parse tree based on the query, the parse tree including a declarative portion and an imperative portion, dividing the parse tree to provide a first parse sub-tree and a second parse sub-tree, the first parse sub-tree including one or more nodes including logical operators for executing the declarative portion and at least one node representing a placeholder for the imperative portion, the second parse sub-tree being representative of the imperative portion, compiling the first parse sub-tree using a declarative compiler to provide a query execution plan (QEP) including an imperative script operator to prompt execution of the imperative portion, compiling the second parse sub-tree using an imperative compiler to provide one or more script execution plans, executing, by an execution engine, the QEP until encountering the imperative script operator, and, in response to encountering the imperative script operator, initiating execution of the one or more script execution plans to provide an imperative result, and providing a query result at least partially including the imperative result. Other implementations include corresponding systems, apparatus, and computer programs, configured to perform the actions of the methods, encoded on computer storage devices.

These and other implementations may each optionally include one or more of the following features: the imperative script operator includes one or more parameters that are provided as input for execution of the one or more script execution plans; execution of the QEP until encountering the imperative script operator provides a partial result, the partial result being combined with the imperative result to provide at least a portion of the query result; the query is based on a syntax for embedding imperative function scripts; the query result is provided absent creation of a database object for processing of imperative functions within the database system; the imperative result includes an in-memory column table; and the execution engine includes a declarative execution engine for executing the QEP and an imperative execution engine for executing the one or more script execution plans.

The present disclosure also provides one or more non-transitory computer-readable storage media coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure may include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example environment that can be used to execute implementations of the present disclosure.

FIG. 2 depicts an example conceptual architecture in accordance with implementations of the present disclosure.

FIG. 3 depicts an example conceptual flow for processing queries in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure include computer-implemented methods for querying a database system. More particularly, implementations of the present disclosure are directed to a hybrid compilation framework for processing queries having arbitrary ad-hoc imperative functions. In some implementations, actions include receiving a query including declarative logic and imperative logic, providing a parse tree based on the query, the parse tree including a declarative portion and an imperative portion, dividing the parse tree to provide a first parse sub-tree and a second parse sub-tree, the first parse sub-tree including one or more nodes including logical operators for executing the declarative portion and at least one node representing a placeholder for the imperative portion, the second parse sub-tree being representative of the imperative portion, compiling the first parse sub-tree using a declarative compiler to provide a query execution plan (QEP) including an imperative script operator to prompt execution of the imperative portion, compiling the second parse sub-tree using an imperative compiler to provide one or more script execution plans, executing, by an execution engine, the QEP until encountering the imperative script operator, and, in response to encountering the imperative script operator, initiating execution of the one or more script execution plans to provide an imperative result, and providing a query result at least partially including the imperative result.

Implementations of the present disclosure are described in further detail with reference to an example query language. The example query language includes the structured query language (SQL) as the language that is used to query the database system. It is contemplated, however, that implementations of the present disclosure can be realized with any appropriate query language.

To provide further context for implementations of the present disclosure, and as introduced above, query languages, such as SQL, however, can have limitations. For example, SQL is a declarative language that enables processing of declarative queries. A declarative language is a programming language that defines what query result is wanted, but does not specify how to achieve the query result. For example, a SQL query follows a convention of selecting what is wanted, where it is found, and any filters that are to be applied (e.g., SELECT . . . FROM . . . WHERE statement). In contrast, an imperative language is a programming language that defines how to obtain a query result, but does not define what query result is wanted.

While a query language, such as SQL, is good for expressing a single query in a declarative way, traditional uses cases often demand imperative logic as well. For example, the imperative logic is used to express conditions, iterations, and exceptions together with multiple queries. In some database systems, database user-defined functions (UDFs) can be used to express imperative logic in queries. However, UDF is a persistent database object that is stored and maintained within the database system. Example UDFs include scalar UDFs (SUDFs), which return single or multiple scalar values, and table UDFs (TUDFs), which return a single table result. Managing persistent database objects, such as UDFs, is a burden on resources (e.g., memory, processors) of the database system, as well as on database programmers and administrators. For example, UDFs imply operational burdens, such as authorization management, resource management, and object revalidation management.

Database systems have seen increased demand to process series of ad-hoc queries, each of which contains a different imperative logic (even if just slightly different). For example, ad-hoc can describe queries that are not predefined (e.g., not expected by the database system), and, for which, database objects, such as UDFs, are not already available in the database system. The operational cost for such ad-hoc queries is significant. For example, if a user-defined imperative logic is changed frequently by application semantics, the UDF for this logic is repeatedly created (e.g., because it does not already exist in the database) or updated (e.g., although existing, the received imperative logic is different). This is not only a time burden, but can be a significant burden on technical resources of the database system. Further, execution of the imperative logic always requires a set of database WRITE updates for the logic describing the UDF. Consequently, the functionality is heavily limited in the transaction point of view, particularly for the users without WRITE privileges. The example following code highlights this issue:

```
CREATE FUNCTION TUDF(op_mode VARCHAR(10), factor FLOAT)
RETURNS TABLE(EMPLOYEE NVARCHAR(50), SIMILARITY FLOAT)
BEGIN
  IF (op_mode = ′DUPLICATE′) THEN
    RESULT = SELECT EMPLOYEE, SIMILARITY FROM FACT_TABLE
                WHERE IS_AUTHORIZED_USER = ′YES′;
  ELSE
    CALL APPROXIMATE_REGRESSION(SIMILARITY, 0.75, :INTERMEDIATE);
    RESULT = SELECT EMPLOYEE, SIMILARITY FROM :INTERMEDIATE
                WHERE IS_AUTHORIZED_USER = ′YES′;
  END IF;
  RETURN :RESULT;
END;
COMMIT; -- Updates DB + Requires DB Write privilege
SELECT * FROM TUDF(‘EXECUTE’, 0.3) UDF
INNER JOIN EMPLOYEE_INFO on UDF.EMPLOYEE = EMPLOYEE_INFO.EMPLOYEE;
DROP FUNCTION TUDF; -- should be cleaned up
COMMIT;
```

Although efforts have been made to describe imperative logic inside declarative logic, practical application is not generalized for the variety of use cases that need to be supported.

In view of this, implementations of the present disclosure provide a hybrid compilation framework for arbitrary ad-hoc imperative functions provided in queries to a database system. More particularly, and as described in further detail herein, a query can include a declarative portion and an imperative portion that is defined based on a function script. In some implementations, the query is parsed to provide a parse tree representative of the declarative portion and the imperative portion. The parse tree is divided to provide a first parse sub-tree and a second sub-parse tree. In some examples, the first parse sub-tree includes one or more nodes representative of the declarative portion and at least one node representing a placeholder for the imperative portion. In some examples, the second parse sub-tree includes nodes representative of the imperative portion.

In some implementations, the first parse sub-tree is compiled using a declarative compiler to provide a query execution plan. In some examples, the query execution plan includes an imperative script operator to prompt execution of the imperative portion. In some examples, the imperative script operator includes one or more parameters. In some implementations, the second parse sub-tree is compiled using an imperative compiler to provide one or more script execution plans. In some implementations, the query execution plan is executed by an execution engine (e.g., including a declarative execution engine) until encountering the imperative script operator. At this point, a first partial result is provided. In response to encountering the imperative script operator, the one or more parameters are provided to an execution engine (e.g., including an imperative script execution engine), which processes the one or more script execution plans based on the one or more parameters to provide a second partial result (e.g., a result table). The first partial result and the second partial result are combined to provide a query result.

Implementations of the present disclosure can be realized for either SUDFs or TUDFs. As described in further detail herein, implementations of the present disclosure enable anonymous UDFs in queries for one-time-used script imperative logic in query statements. This is provided directly as a part of a query statement without any database object being created. Accordingly, implementations of the present disclosure provide advantages over approaches using database objects (e.g., UDFs). For example, implementations of the present disclosure enable query execution with imperative logic, but without any database object creation. This also implies the execution framework is open to the READ-ONLY transaction, or the users without WRITE privileges. As another example, implementations of the present disclosure enable query execution collaborated with the non-query language (e.g., SQL query execution collaborated with non-SQL language), based on the syntactic coverage that is supported by the database system. By way of non-limiting example, a database system can support XML/JSON structure as a string constant. With the anonymous UDF framework, all these can be embedded as a partial execution plan for query execution.

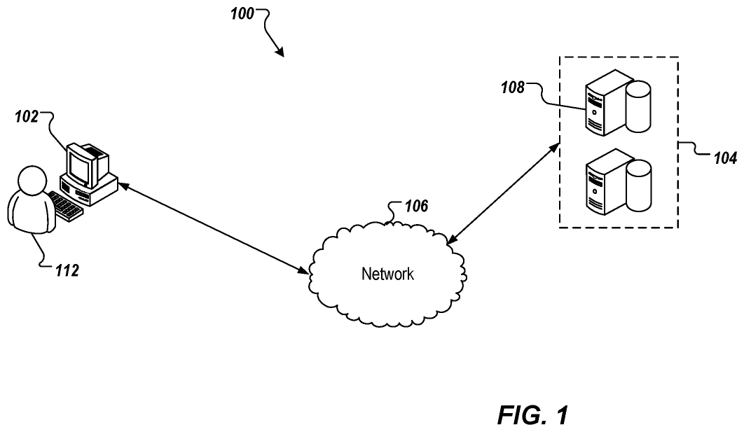

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, the server system 104 can host a database system. For example, the server system 104 can host an in-memory database system. An example in-memory database system includes SAP HANA provided by SAP SE of Walldorf, Germany. In general, an in-memory database system uses main memory for data storage. Main memory may include one or more types of memory (e.g., DRAM, NVM) that communicates with one or more processors (e.g., CPU(s)) over a memory bus. An in-memory database system may be contrasted with database management systems that employ a disk storage mechanism. In some examples, in-memory database systems may be faster than disk storage databases, because internal optimization algorithms may be simpler and execute fewer instructions. In some examples, accessing data in an in-memory database system may reduce or eliminate seek time when querying the data, providing faster and more predictable performance than disk-storage databases.

As introduced above, implementations of the present disclosure provide a hybrid compilation framework for arbitrary ad-hoc imperative functions provided in queries to a database system. More particularly, and as described in further detail herein, a query can include a declarative portion and an imperative portion that is defined based on a function script. In some examples, the function script can be considered as being embedded in the query. Example syntax for embedding (imperative) function scripts can be provided as:

<from_clause> = FROM <table_from>
<table_from> = <table> | <table_from> ‘,’ <table>
<table> = <basetable> | <subquery_with_parens> <opt_table_alias> |
<joined table> | <tablesample>
<basetable> = <table_ref> <opt_table_alias> | .... . |
<embedded_function> <opt_table_alias>
<embedded_function> = SQL FUNCTION <embedded_func_param list>
<func_return> BEGIN <sqlscript_body> END
<embedded_func_param list> = (empty string) | ‘(‘ ‘)’ | ‘(‘
<embedded_func_param> ‘)’
<embedded_func_param> = <proc_param_mode> <proc_param_name>
<proc_data_type> ARG_ASSIGN_OP <proc_expr>
<func_return> = RETURNS <table_ref> | RETURNS TABLE ‘(‘
<column_list> ‘)’

### Example Syntax

Using the above example syntax, example code can be provided as:

```
SELECT * FROM
    SQL FUNCTION (op_mode VARCHAR(10) = > ‘EXECUTE’, factor FLOAT => 0.3)
RETURNS TABLE(EMPLOYEE NVARCRAR(50), SIMILARITY FLOAT)
BEGIN
  IF (op_mode = ′DUPLICATE′) THEN
    RESULT = SELECT EMPLOYEE, SIMILARITY FROM FACT_TABLE
                WHERE IS_AUTHORIZED_USER = ′YES′;
  ELSE
    CALL APPROXIMATE_REGRESSION(SIMILARITY, 0.75, :INTERMEDIATE);
    RESULT = SELECT EMPLOYEE, SIMILARITY FROM :INTERMEDIATE
                WHERE IS_AUTHORIZED_USER = ′YES′;
  END IF;
  RETURN :RESULT;
END UDF INNER JOIN EMPLOYEE_INFO on UDF.EMPLOYEE =
EMPLOYEE_INFO.EMPLOYEE;
```

### Example Code

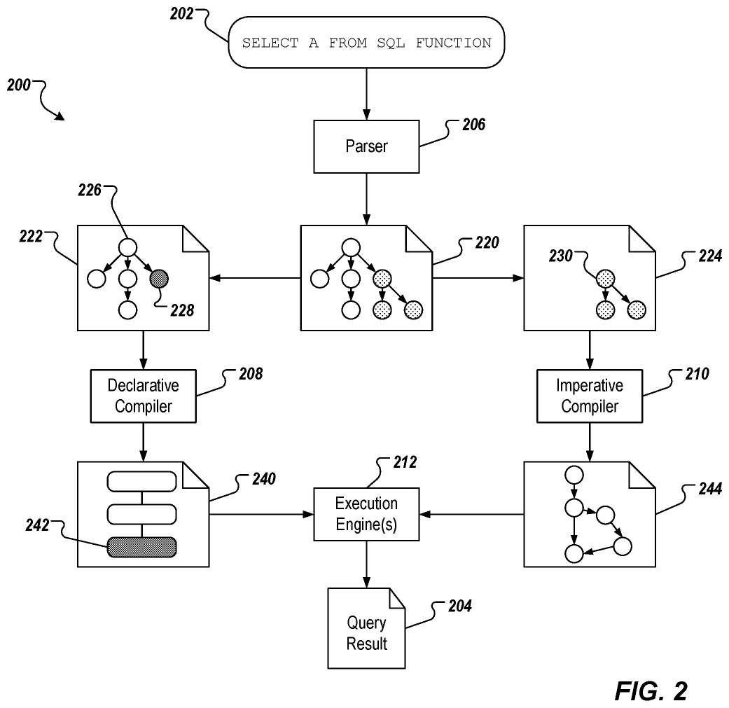

FIG. 2 depicts an example conceptual architecture 200 in accordance with implementations of the present disclosure. The example conceptual architecture 200 depicts an example execution of a query 202 to provide a query result 204. In some examples, the query 202 includes a function script (imperative function script) embedded therein, such as the example code provided above. The example conceptual architecture 200 includes a parser 206, a declarative compiler 208, an imperative compiler 210, and one or more execution engines 212.

In some implementations, the parser 206 is provided as a lexical syntax parser (e.g., SAP HANA Lexical Syntax Parser) that processes the query to identify declarative logic and imperative logic, if any, therein. In some examples, if the query does not include imperative logic (e.g., is absent an embedded function script), the query is processed as a traditional declarative query. In some examples, if the query includes imperative logic (e.g., such as the example code above), the parser 206 provides a parse tree 220 representative of the declarative portion and the imperative portion. The parse tree 220 is divided to provide a first parse sub-tree 222 and a second sub-parse tree 224. In some examples, the first parse sub-tree 222 includes one or more nodes 226 representative of the declarative portion (e.g., each node representing a logical operation that is to be executed) and at least one node 228 representing a placeholder for the imperative portion. In some examples, the second parse sub-tree 224 includes one or more nodes 230 representative of the imperative portion.

In some implementations, the first parse sub-tree 222 is compiled by the declarative compiler 208 to provide a query execution plan 240. In some examples, the query execution plan 208 includes an imperative script operator 242 to prompt execution of the imperative portion. In some examples, the imperative script operator 242 includes one or more parameters. For the declarative query compilation, the whole imperative logic block is considered as a reading from a temporary table object. However, this is considered as a compilation-scope generic operator object and does not create any persistent or volatile database objects. In some implementations, the second parse sub-tree 224 is compiled by the imperative compiler 210 to provide a script execution plan 244. In some examples, the compilations are executed in parallel. In some examples, the compilations are executed in series.

In some implementations, an execution plan can be provided as a collection of the (declarative) query execution plan 240 and the (imperative) script execution plan 244. Because the declarative execution plan 240 and the imperative execution plan 244 can be considered components of a single, overall query execution plan and both are required to execute the outermost query, their lifecycles or ownerships are shared for their parent execution plan. More particularly, each QEP has a certain lifecycle based on its validity, and a QEP is removed from the memory when validity is lost. There are several reasons that can make the QEP invalid. For example, the touching database objects are updated for its signature, and the accessed database content is updated that makes the current QEP no longer optimal. Because the current imperative execution plan is the part of the QEP (which can be considered a parent), it is not shared to other similar execution plan, it affects the validity of the ‘parent’ QEP, if it accesses the other database objects, it is valid only when the ‘parent’ QEP is valid, and it is dropped when the ‘parent’ QEP becomes invalid and dropped.

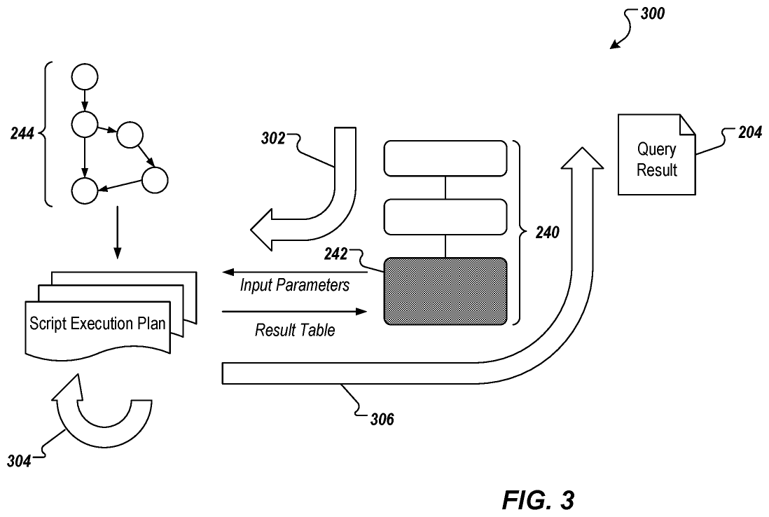

FIG. 3 depicts an example execution 300 of the (declarative) execution plan 240 and the (imperative) script execution plan 244 of FIG. 2 in accordance with implementations of the present disclosure. In some implementations, the query execution plan is executed (302) by the execution engine 212 (e.g., including a declarative execution engine). In some examples, a declarative query execution starts with the given declarative execution plan and can start from the leaf nodes of the execution plan tree. In some implementations, execution of the declarative execution plan is performed until encountering the imperative script operator 242. At this point, a first partial result is provided.

In response to encountering the imperative script operator 242, the one or more parameters are provided within the execution engine 212 (e.g., including an imperative script execution engine), which processes (304) the script execution plan 244 based on the one or more parameters to provide a second partial result. For example, the string parameter ‘EXECUTE’ and float value 0.3 is given as parameter, to execute the imperative script execution engine. In some examples, the second partial result is provided as a result table (e.g., an in-memory column table).

In some implementations, after the imperative execution is done, the result table is provided (306) to the declarative query execution engine, and bottom-up execution of the declarative execution plan is performed. In some examples, the declarative execution engine considers the imperative execution results (i.e., the result table 302) as a temporary column table and provides the declarative query execution results. In this manner, the first partial result and the second partial result are combined to provide the query result 204.

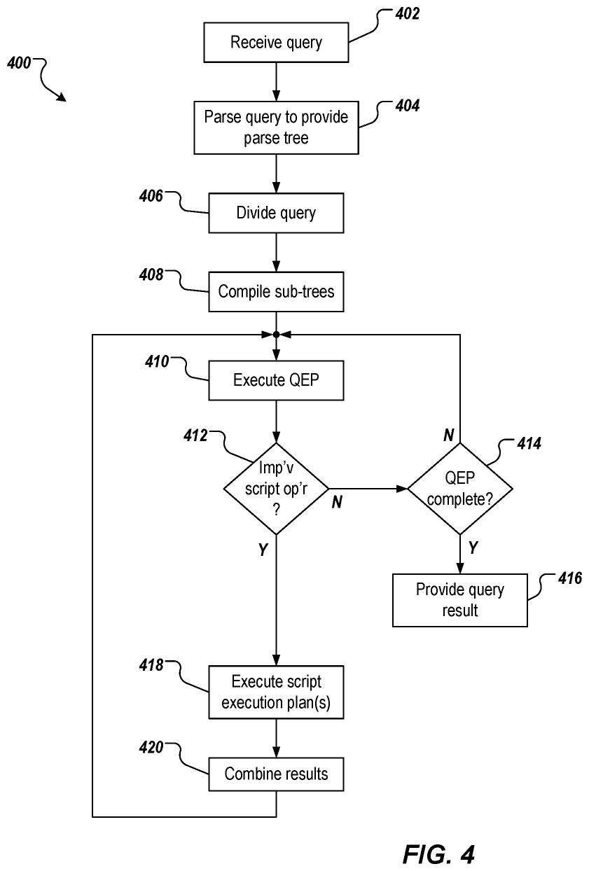

FIG. 4 depicts an example process 400 that can be executed in accordance with implementations of the present disclosure. In some implementations, the example process 400 may be performed using one or more computer-executable programs executed using one or more computing devices. The example process 400 can be performed for executing queries that include declarative logic and imperative logic in database systems.

A query including declarative logic and imperative logic is received (402). For example, a query is submitted to a database system (e.g., from a client-side application). In some examples, the query is based on a syntax for embedding imperative function scripts. A parse tree is provided based on the query (404). For example, a parser processes the query to provide the parse tree. In accordance with implementations of the present disclosure, the parse tree includes a declarative portion and an imperative portion.

The parse tree is divided to provide a first parse sub-tree and a second parse sub-tree (406). In some examples, the first parse sub-tree includes one or more nodes representing logical operators for executing the declarative portion. In some examples, at least one node of the first parse sub-tree represents a placeholder for the imperative portion. In some examples, the second parse sub-tree is representative of the imperative portion. The sub-trees are compiled (408). For example, the first parse sub-tree is compiled using a declarative compiler to provide a QEP (e.g., a declarative execution plan) that includes an imperative script operator. In some examples, the imperative script operator prompts execution of the imperative portion. In some examples, the second parse sub-tree is compiled using an imperative compiler to provide one or more script execution plans.

The QEP is executed (410). For example, an execution engine executes logical operations provided within the QEP. In some examples, the execution engine includes a declarative execution engine for executing the QEP. It is determined whether an imperative script operator is encountered (412). If it is determined that an imperative script operator has not been encountered, it is determined whether execution of the QEP is complete (414). If execution of the QEP is complete, a query result is provided (416). For example, the query result includes the result of one or more declarative functions and one or more imperative functions of the query. If execution of the QEP is not complete, the example process 400 loops back to continue execution of the QEP.

If it is determined that an imperative script operator has not been encountered, one or more script execution plans are executed (418). In some examples, one or more parameters are provided from the imperative script operator of the QEP for execution of the one or more script execution plans. In some examples, the one or more script execution plans are executed to provide an imperative result. Results are combined (420), and the example process 400 loops back to continue execution of the QEP. In some examples, the imperative result is combined with a partial result of the QEP that is provided at the time of encountering the imperative script operator of the QEP.

As described herein, implementations of the present disclosure provide one or more advantages. For example, for users of a database system including the hybrid compilation framework of the present disclosure, a simplified development/deployment experience is provided. That is, for example, functions (DDL functions) need not be created/altered/dropped for ad-hoc queries, which are generated for a specific purpose and used only once or few times. As another example, users are free from cumbersome privilege operations that would be needed for any (even minor) changes in a TUDF. This enables imperative logic execution for users who do not have database-write privileges, since it does not require any TUDF object created for the intended imperative logic. As another example, system resources are conserved and a higher concurrency is provided. For example, database logs do not need to be written, metadata locks need to be acquired, and object dependencies need not be managed, as traditionally required for every DDL execution.

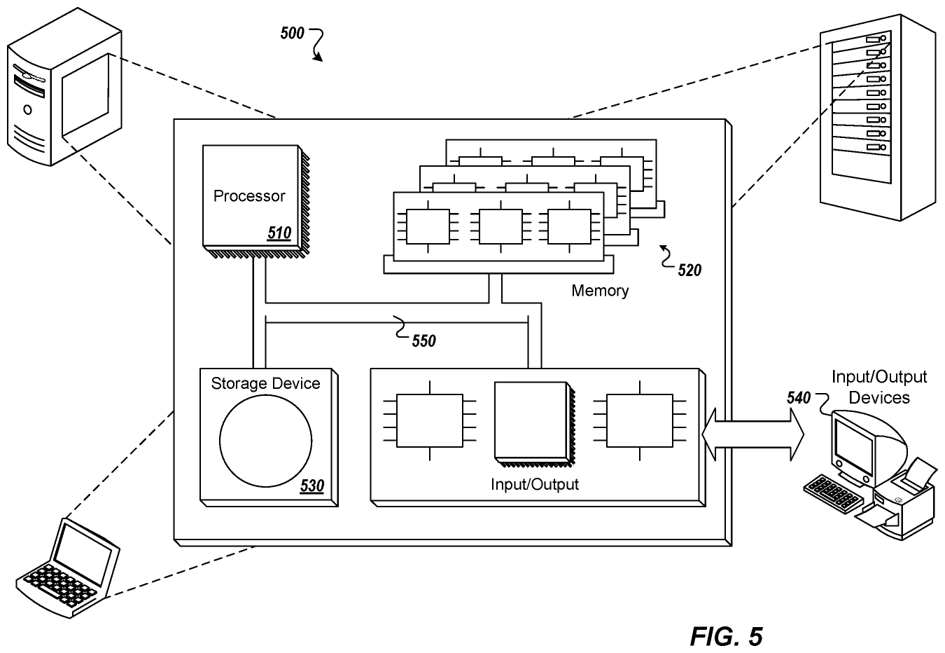

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

Implementations of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively, or in addition, the carrier may be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, an engine, a script, or code, can be written in any form of programming language, including compiled or interpreted languages, or declarative or procedural languages; and it can be deployed in any form, including as a stand-alone program or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. Elements of a computer can include a central processing unit for executing instructions and one or more memory devices for storing instructions and data. The central processing unit and the memory can be supplemented by, or incorporated in, special-purpose logic circuitry.

Generally, a computer will also include, or be operatively coupled to receive data from or transfer data to one or more mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, implementations of the subject matter described in this specification can be implemented on, or configured to communicate with, a computer having a display device, e.g., a LCD (liquid crystal display) monitor, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

While this specification contains many specific implementation details, these should not be construed as limitations on the scope of what is being claimed, which is defined by the claims themselves, but rather as descriptions of features that may be specific to particular implementations. Certain features that are described in this specification in the context of separate implementations can also be realized in combination in a single implementation. Conversely, various features that are described in the context of a single implementations can also be realized in multiple implementations separately or in any suitable subcombination. Moreover, although features may be described above as acting in certain combinations and even initially be claimed as such, one or more features from a claimed combination can in some cases be excised from the combination, and the claim may be directed to a subcombination or variation of a sub combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for executing queries that include declarative logic and imperative logic in database systems, the method comprising:
receiving a query comprising declarative logic and imperative logic;
providing a parse tree based on the query, the parse tree comprising a declarative portion and an imperative portion;
dividing the parse tree to provide a first parse sub-tree and a second parse sub-tree, the first parse sub-tree comprising one or more nodes comprising logical operators for executing the declarative portion and at least one node representing a placeholder for the imperative portion, the second parse sub-tree being representative of the imperative portion;
compiling the first parse sub-tree using a declarative compiler to provide a query execution plan (QEP) comprising an imperative script operator to prompt execution of the imperative portion;
compiling the second parse sub-tree using an imperative compiler to provide one or more script execution plans;
executing, by an execution engine, the QEP until encountering the imperative script operator, and, in response to encountering the imperative script operator, initiating execution of the one or more script execution plans to provide an imperative result; and
providing a query result at least partially comprising the imperative result.

2. The method of claim 1, wherein the imperative script operator comprises one or more parameters that are provided as input for execution of the one or more script execution plans.

3. The method of claim 1, wherein execution of the QEP until encountering the imperative script operator provides a partial result, the partial result being combined with the imperative result to provide at least a portion of the query result.

4. The method of claim 1, wherein the query is based on a syntax for embedding imperative function scripts.

5. The method of claim 1, wherein the query result is provided absent creation of a database object for processing of imperative functions within the database system.

6. The method of claim 1, wherein the imperative result comprises an in-memory column table.

7. The method of claim 1, wherein the execution engine comprises a declarative execution engine for executing the QEP and an imperative execution engine for executing the one or more script execution plans.

8. A non-transitory computer-readable storage medium coupled to one or more processors and having instructions stored thereon which, when executed by the one or more processors, cause the one or more processors to perform operations for executing queries that include declarative logic and imperative logic in database systems, the operations comprising:
receiving a query comprising declarative logic and imperative logic;
providing a parse tree based on the query, the parse tree comprising a declarative portion and an imperative portion;
dividing the parse tree to provide a first parse sub-tree and a second parse sub-tree, the first parse sub-tree comprising one or more nodes comprising logical operators for executing the declarative portion and at least one node representing a placeholder for the imperative portion, the second parse sub-tree being representative of the imperative portion;
compiling the first parse sub-tree using a declarative compiler to provide a query execution plan (QEP) comprising an imperative script operator to prompt execution of the imperative portion;
compiling the second parse sub-tree using an imperative compiler to provide one or more script execution plans;
executing, by an execution engine, the QEP until encountering the imperative script operator, and, in response to encountering the imperative script operator, initiating execution of the one or more script execution plans to provide an imperative result; and
providing a query result at least partially comprising the imperative result.

9. The computer-readable storage medium of claim 8, wherein the imperative script operator comprises one or more parameters that are provided as input for execution of the one or more script execution plans.

10. The computer-readable storage medium of claim 8, wherein execution of the QEP until encountering the imperative script operator provides a partial result, the partial result being combined with the imperative result to provide at least a portion of the query result.

11. The computer-readable storage medium of claim 8, wherein the query is based on a syntax for embedding imperative function scripts.

12. The computer-readable storage medium of claim 8, wherein the query result is provided absent creation of a database object for processing of imperative functions within the database system.

13. The computer-readable storage medium of claim 8, wherein the imperative result comprises an in-memory column table.

14. The computer-readable storage medium of claim 8, wherein the execution engine comprises a declarative execution engine for executing the QEP and an imperative execution engine for executing the one or more script execution plans.

15. A system, comprising:
one or more computers; and
a computer-readable storage device coupled to the computing device and having instructions stored thereon which, when executed by the computing device, cause the computing device to perform operations for executing queries that include declarative logic and imperative logic in database systems, the operations comprising:
receiving a query comprising declarative logic and imperative logic;
providing a parse tree based on the query, the parse tree comprising a declarative portion and an imperative portion;
dividing the parse tree to provide a first parse sub-tree and a second parse sub-tree, the first parse sub-tree comprising one or more nodes comprising logical operators for executing the declarative portion and at least one node representing a placeholder for the imperative portion, the second parse sub-tree being representative of the imperative portion;
compiling the first parse sub-tree using a declarative compiler to provide a query execution plan (QEP) comprising an imperative script operator to prompt execution of the imperative portion;
compiling the second parse sub-tree using an imperative compiler to provide one or more script execution plans;
executing, by an execution engine, the QEP until encountering the imperative script operator, and, in response to encountering the imperative script operator, initiating execution of the one or more script execution plans to provide an imperative result; and
providing a query result at least partially comprising the imperative result.

16. The system of claim 15, wherein the imperative script operator comprises one or more parameters that are provided as input for execution of the one or more script execution plans.

17. The system of claim 15, wherein execution of the QEP until encountering the imperative script operator provides a partial result, the partial result being combined with the imperative result to provide at least a portion of the query result.

18. The system of claim 15, wherein the query is based on a syntax for embedding imperative function scripts.

19. The system of claim 15, wherein the query result is provided absent creation of a database object for processing of imperative functions within the database system.

20. The system of claim 15, wherein the imperative result comprises an in-memory column table.
